(19) United States
(12) Patent Application Publication
(10) Pub. No.: US 2010/0289254 A1
(43) Pub. Date: Nov. 18, 2010

(54) PUSHCHAIRS

(75) Inventors: Charlotte Evans, Berkshire (GB); Carolin Jarvis, Berkshire (GB)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: INSIDEOUT INNOVATIONS LTD., Berkshire (GB)

(21) Appl. No.: 12/444,644

(22) PCT Filed: Oct. 8, 2007
(86) PCT No.: PCT/GB07/50619

§ 371 Date: Apr. 7, 2009

(30) Foreign Application Priority Data
Oct. 7, 2006 (GB) 0619793.3
Mar. 21, 2007 (GB) 0705375.4

(51) Int. Cl. B60R 9/06

(52) U.S. Cl. 280/769

(57) ABSTRACT

A device for attachment to the rear of a pushchair (10), comprises a pair of arms (20L), (20R) having fastening means (22L, 22R) at their inner ends for pivotal attachment to respective side uprights (11L,11R) of the pushchair (10) and having ground-engaging wheels (27L,27R) at their outer ends, the device further comprising a support member (31) arranged to detachably engage the arms (20L,20R) intermediate respective opposite ends thereof. In one embodiment (FIGS. 1 to 4) the support member (31) supports a bag (30). In another embodiment (FIGS. 5 and 6) the support member (31) acts as a platform on which a person can stand. In order to collapse the pushchair (10), the support member (31) can simply be removed to allow the two arms (20L,20R) of the device to come together.

This invention relates to pushchairs and more particularly to a device for attaching to the rear of a pushchair, in order to enable goods or persons to be transported behind the pushchair.

Pushchairs are widely used for transporting infants. A typical pushchair comprises one or sometimes two seats, supported by a frame having a pair of front and rear uprights provided with wheels at their lower ends.

It is known to mount a wheeled platform device behind a conventional pushchair for transporting a second child in the standing position. One such device is disclosed in European Patent Application No. EP1550596.

The frames of most pushchairs are collapsible, either in one plane by bringing the respective rear and front uprights together, or in two planes in which the left and right uprights as well as the front and rear uprights are brought together.

A disadvantage of platform devices of the type disclosed in EP 1 550 596 is that the platform prevents the left and right uprights from being brought together. Accordingly, it can be difficult to collapse a pushchair when fitted with such a platform device.

We have now devised a device for attachment to the rear of a pushchair which alleviates the above-mentioned problems.

In accordance with this invention, there is provided a device for attachment to the rear of a pushchair, the device comprising a pair of arms having fastening means at their inner end for attachment to respective side uprights of the pushchair and having ground-engaging wheels at their outer ends, the device further comprising a support member arranged to detachably engage said arms intermediate respective opposite ends thereof.

In use, a second child can stand or sit on the support member, in order to be transported behind the pushchair. Alternatively, the support member can be used to carry bags and other articles.

In order to collapse the pushchair, the support member can simply be removed to allow the two arms of the device to come together.

Preferably the support member is flat, the arms being arranged in use to hold the support member in a generally horizontal configuration.

Preferably catch means are provided for locking the support member to the arms.

Preferably said wheels are arranged to caster, said support member lying in a plane which extends substantially normal to the axis of rotation about which said wheels caster.

Preferably said support member is arranged to seat on formations disposed on said arms.

Preferably each of said formations comprises a slot or a channel for receiving a complementary formation on respective lateral sides of said support member.

Preferably said arms comprise formations at their inner ends for fastening to corresponding side uprights of the pushchair.

Preferably said formations are pivoted to said arms for rotation about an axis which extends normal to the longitudinal axis thereof.

Preferably said wheels are mounted to respective outer end portions of the arms, which outer ends portions are arranged for rotation about an axis which extends normal to the longitudinal axis of the arm and preferably parallel to the axis of rotation of said upright-engaging formations.

Preferably means are provided for locking said end portions of the arms against rotation.

Preferably said support member is arranged to detachably engage said outer end portions of the arms.

Preferably the arms each comprise a member which extends from its outer end for connecting to the respective upright of the pushchair at a point remote from the upper end of the arm, in order to control the angle of inclination of the arm relative to the upright.

Preferably said member comprises a strap or other elongate flexible member.

Preferably said arms are longitudinally extendable.

Preferably said support member is fastened or arranged for fastening to a bag or container for transporting goods.

Preferably said support member is fastened to the base of the bag or container and may form the base thereof.

Preferably means are provided for connecting the uprights of the pushchair to the upper end of the bag.

Alternatively, the support member may be fastened or arranged for fastening to a seat or platform on which a child can respectively sit or stand.

Embodiments of the present invention will now be described by way of examples only, and with reference to the accompanying drawings, in which:

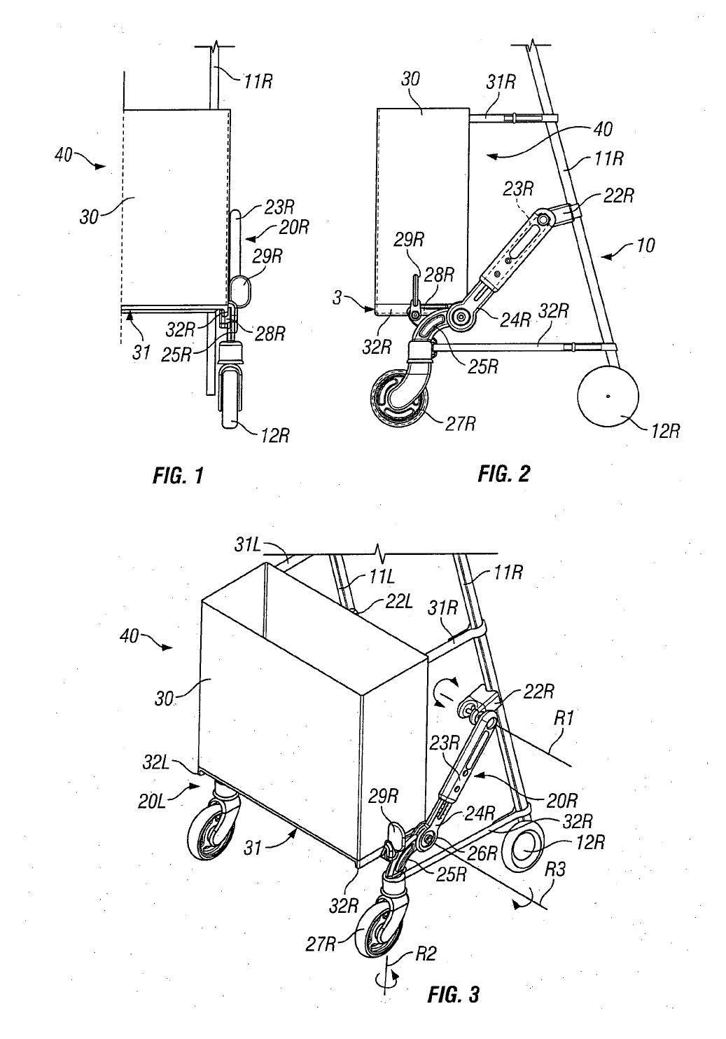

FIG. 1 is a rear view of the right hand side of an embodiment of pushchair attachment device in accordance with the present invention, when attached to a pushchair;

FIG. 2 is a right side view of the device of FIG. 1;

FIG. 3 is a perspective view from above of the right hand side of the device of FIG. 1;

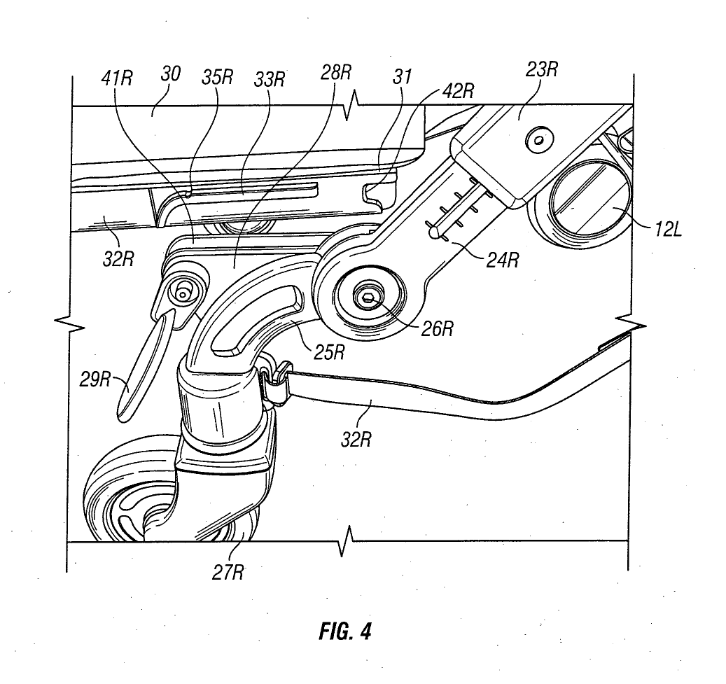

FIG. 4 is a perspective view of the lower end of the right hand arm of the device of FIG. 1;

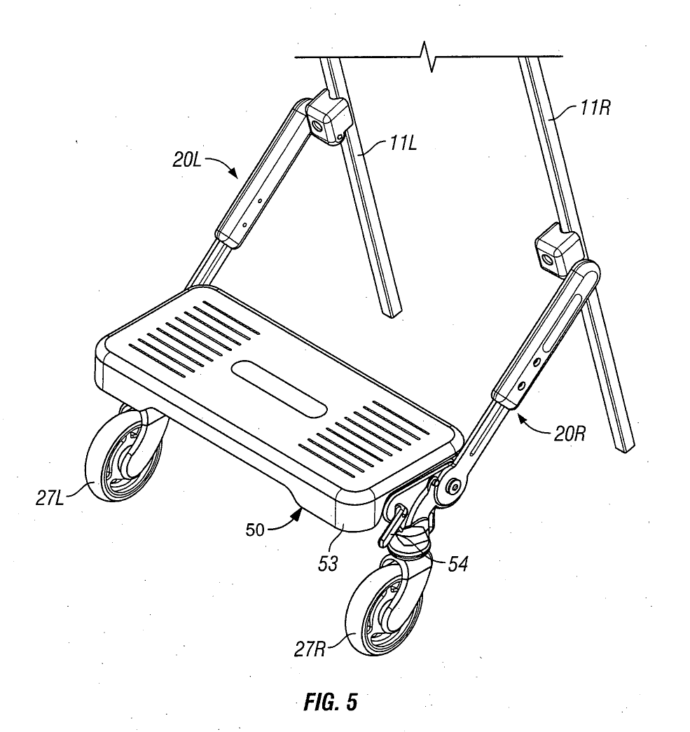

FIG. 5 is a perspective view of an alternative embodiment of pushchair attachment device in accordance with the present invention, when attached to a pushchair and configured for carrying a child; and

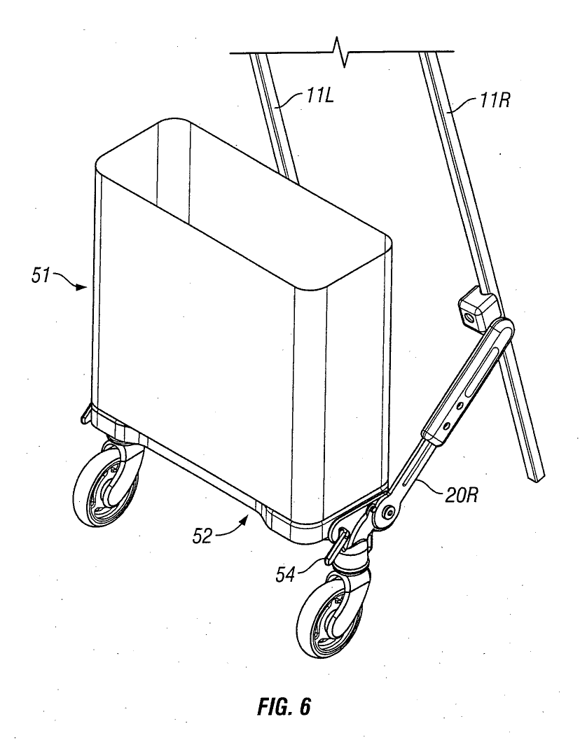

FIG. 6 is a perspective view of the device of FIG. 5 when attached to a pushchair and configured for carrying a bag.

Referring to the drawings, there is shown a device 40 for attaching to the rear of a conventional pushchair 10. As will be described hereinafter, the device 40 comprises left and right arms 20L, 20R which are symmetrical in construction and which are arranged for connecting to respective uprights 11L, 11R of the pushchair 10. Like left and right parts of the pushchair 10 and the device 40 are given the same reference numerals but have the suffix L and R respectively. The following description will mainly refer to parts on the right hand side, though it will be appreciated that the description applies equally to parts of the left hand side.

The left and right uprights 11L, 11R of the pushchair 10 are provided with respective wheels e.g. 12R at their lower ends. The arms 20R is fastened at its inner end to the uprights 11R of the pushchair 10 by means of a fastening 22R that enables the arm to be pivoted about a horizontal axis R1 of rotation, from a stowed position in which it is upwardly inclined into the deployed condition shown in the drawings. The arm 20R is provided with a wheel 27R at its outer end. The wheel is arranged to castor about a vertical axis R2 of rotation.

The arm 20R comprises an elongate central portion having telescopically interconnected inner and outer ends 23R, 24R which can be locked together at the desired extension. The outer end 24R of the central portion is pivotally connected by a bolt 26R to an arcuate portion 25R, which curves downwardly through 90° and is connected at its lower end to the wheel 27R. The attitude of the arcuate portion 25R relative to the elongate central portion of the arm 20R can be adjusted by rotation of the portion 25R about a horizontal axis R3 of rotation, which extends parallel to the axis R1 of rotation. The bolt 26R can be tightened to lock the arcuate portion 25R at the desired angle.

The arcuate portion 25R of the arm 20R is provided with a channel-shaped formation 28R on its inner side face, which opposes the corresponding face of the other arm 20L. The channel shaped formation 28R comprises an upwardly-facing channel 41R, which extends rearwardly of the pushchair 10, the inclination of the channel 41R being set to horizontal by rotation of the arcuate portion 25R of the arm about the axis R3 of rotation. A catch 29R is rotatably mounted to the rear end of the channel shaped formation 28R.

A bag 30 having a rectangular base is provided for mounting between the arms 20L, 20R. The base of the bag 30 is securely fastened to a rectangular plate 31 having depending flanges 32L, 32R extending along its lower surface at respective opposite ends thereof. The flanges 32L, 32R are arranged to be received in the channels eg 41R of the respective channel-shaped formations. The flange 32R is provided with a forwardly-facing cut-out 42R at one end for engaging with a respective formation (not shown) on the inner end of the channel 41R. A shoulder 33R projects laterally outwardly from the end of the plate 31, the catch 29R being arranged to pivot upwardly to engage over the shoulder 33R, in order to securely hold the bag 30 in situ. The catch 29R preferably engages in a detent 35R formed in the shoulder 33R.

The upper end of the bag 30 comprises straps 31L, 31R, which can be detachably engaged with the respective uprights 11L, 11R of the pushchair 10.

An elongate flexible strap 32R extends from the outer end of the arcuate portion 25R of the arm for engaging the lower end of the upright 11R of the pushchair 10.

In use, the arms 20L, 20R trail on their wheels 27L, 20R behind the pushchair and support the bag 30. The arms 20L, 20R are able to pivot upwardly and downwardly about the axis R1 as the pushchair 10 is maneuvered over the ground surface. The straps e.g. 32R can be tensioned to control the angle through which the arms 20L, 20R are allowed to pivot.

In order to collapse the pushchair, the catches 29R can be released to allow the bag 30 to be removed. The arms 20L, 20R can then be pivoted upwardly against the uprights 11L, 11R of the pushchair 10 and clips or other fastening members (not shown) may be provided for holding the arms 20L, 20R in their stowed position.

The bag 30 can be taken away and used to transport goods. Alternatively, it may be folded and stowed.

Referring to FIG. 5 of the drawings, there is shown an alternative embodiment of pushchair attachment device which is similar in principle to the device of FIGS. 1 to 4 and like parts are given like reference numerals. In this embodiment a separate plate 50 is be provided for mounting between the legs 20L, 20R, so that the plate can be used as a platform on which a child can stand behind the pushchair.

Referring to FIG. 5 of the drawings, the plate 50 can be removed and replaced by a bag 51 having a base 52 which extends between the legs 20L, 20R. In this embodiment the side edges of the plate 50 and base 52 comprise a peripheral depending flange 53, having opposite end portions which are removably received in the respective channels of the legs 20L, 20R. The flange 53 is retained in situ in each channel by a spring biassed pin which engages into an aperture formed in the flange 53. A cam lever 54 is provided for moving the pin in and out of the channel to engage and disengage the flange 53.

A device in accordance with the present invention is simple and inexpensive in construction, yet enables goods or persons to be transported behind a pushchair in a manner which enables the pushchair to be collapsed when not in use.

1-19. (canceled)

20. A device for attachment to the rear of a pushchair, the device comprising a pair of arms having fastening means at their inner end for attachment to respective side uprights of the pushchair and having ground-engaging wheels at their outer ends, the device further comprising a support member arranged to detachably engage said arms intermediate respective opposite ends thereof.

21. A device as claimed in claim 20, in which the support member is flat, the arms being arranged in use to hold the support member in a generally horizontal configuration.

22. A device as claimed in claim 20, in which catch means are provided for locking the support member to the arms.

23. A device as claimed in claim 20, in which said wheels are arranged to caster, said support member lying in a plane which extends substantially normal to the axis of rotation about which said wheels caster.

24. A device as claimed in claim 20, in which said support member is arranged to seat on formations disposed on said arms.

25. A device as claimed in claim 24, in which each of said formations comprises a slot or a channel for receiving a complementary formation on respective lateral sides of said support member.

26. A device as claimed in claim 20, in which said arms comprise formations at their inner ends for fastening to corresponding side uprights of the pushchair.

27. A device as claimed in claim 26, in which said arm formations are pivoted to said arms for rotation about an axis which extends normal to the longitudinal axis thereof.

28. A device as claimed in claim 20, in which said wheels are mounted to respective outer end portions of the arms, which outer ends portions are arranged for rotation about an axis which extends normal to the longitudinal axis of the arm.

29. A device as claimed in claim 28, in which said wheels are mounted to respective outer end portions of the arms, which outer ends portions are arranged for rotation about an axis which extends normal to the longitudinal axis of the arm and parallel to the axis of rotation of said upright-engaging formations.

30. A device as claimed in claim 28, in which means are provided for locking said end portions of the arms against rotation.

31. A device as claimed in claim 20, in which said support member is arranged to detachably engage said outer end portions of the arms.

32. A device as claimed in claim 20, in which the arms each comprise a member which extends from its outer end for connecting to the respective upright of the pushchair at a point remote from the upper end of the arm, in order to control the angle of inclination of the arm relative to the upright.

33. A device as claimed in claim 32, in which said member comprises a strap or other elongate flexible member.

34. A device as claimed in claim 20, in which said arms are longitudinally extendable.

35. A device as claimed in claim 20, in which said support member is fastened or arranged for fastening to a bag or container for transporting goods.

36. A device as claimed in claim 35, in which said support member is fastened to the base of the bag or container.

37. A device as claimed in claim 35, in which said support member forms the base of the bag.

38. A device as claimed in claim 35, in which means are provided for connecting the uprights of the pushchair to the upper end of the bag.
